(19) United States
(12) Patent Application Publication
(10) Pub. No.: US 2011/0211087 A1
(43) Pub. Date: Sep. 1, 2011

(54) METHOD AND APPARATUS PROVIDING FOR CONTROL OF A CONTENT CAPTURING DEVICE WITH A REQUESTING DEVICE TO THEREBY CAPTURE A DESIRED CONTENT SEGMENT

(75) Inventors: Sujeet Shyamsundar Mate, Tampere (FI); Radu Ciprian Bilcu, Tampere (FI); Igor Danilo Diego Curcio, Tampere (FI)

(73) Assignee: Nokia Corporation

(21) Appl. No.: 12/713,955

(22) Filed: Feb. 26, 2010

(51) Int. Cl. G06K 9/34; H04N 5/228

(52) U.S. Cl. 348/222.1; 382/173; 348/E05.031

(57) ABSTRACT

An apparatus providing for transmission of a desired content segment to a receiving device may include a content preview unit for displaying a content preview corresponding to a content segment captured by a content capturing device. A content capturing device selector may receive a selection of the content capturing device which satisfies one or more predefined conditions as determined by a condition testing unit of the apparatus. Once selected, a control unit may allow for control of the content capturing device with the receiving device to thereby capture a desired content segment. Control may occur directly or indirectly, such as through providing written control instructions, which may be translated using a translator of the apparatus. Thus, the apparatus may provide for transmission of the desired content segment to the receiving device.

### TECHNOLOGICAL FIELD

Embodiments of the present invention relate generally to capturing content remotely and, more particularly, relate to an apparatus, method and a computer program product providing for control of a content capturing device with a requesting device to thereby capture a desired content segment.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels are utilizing mobile terminals to communicate with other individuals or contacts, receive services and/or share information, media and other content.

One of the technologies which is often incorporated into modern mobile terminals is that of cameras which may capture video and/or picture content. Thus, given the prolific nature of mobile devices, at any given time there may be a person at a location with a mobile terminal which could capture content from that location which would be of interest to a remotely located person. However, the remotely located person may not know how to contact the person with the mobile terminal. Further, even if the remotely located person could contact the person with the mobile terminal, it might be difficult to instruct the person with the mobile terminal as exactly what content he or she wants to have captured. Additionally, in some instances the remotely located person may want to see content captured at other locations, but he or she may not know where to look for the type of scenery that they is of interest. Thus, even if the remotely located user were able to contact the person with the mobile terminal, the captured content might ultimately be of no interest to the remotely located user.

Accordingly it may be desirable to provide an improved method and apparatus providing for control of a content capturing device with a requesting device to thereby capture a desired content segment.

### BRIEF SUMMARY OF THE INVENTION

A method, apparatus and computer program product are therefore provided that may provide for selection and control of a content capturing device at a location of interest through use of a content preview. Thus, for example, it may be possible to capture a desired content segment.

In an example embodiment, an improved apparatus comprises at least one processor and at least one memory including computer program code, the at least one memory and the computer program code configured to, with the processor, cause the apparatus to at least perform receiving a content segment and a location indicator corresponding to a location at which the content segment was captured from a content capturing device, providing for display of the location indicator and a content preview corresponding to the content segment on a requesting device in instances in which the content capturing device satisfies one or more predefined conditions, receiving a selection of the content capturing device which satisfies the one or more predefined conditions with the requesting device, providing for control of the content capturing device which is selected with the requesting device to thereby capture a desired content segment, and providing for transmission of the desired content segment to the receiving device.

In an additional example embodiment a method comprises receiving a content segment and a location indicator corresponding to a location at which the content segment was captured from a content capturing device, providing for display of the location indicator and a content preview corresponding to the content segment on a requesting device in instances in which the content capturing device satisfies one or more predefined conditions, receiving a selection of the content capturing device which satisfies the one or more predefined conditions with the requesting device, providing for control of the content capturing device which is selected with the requesting device to thereby capture a desired content segment, and providing for transmission of the desired content segment to the receiving device.

In a further example embodiment a computer program product comprises at least one computer-readable storage medium having computer-executable program code portions stored therein, the computer-executable program code portions comprising program code instructions for receiving a content segment and a location indicator corresponding to a location at which the content segment was captured from a content capturing device, program code instructions providing for display of the location indicator and a content preview corresponding to the content segment on a requesting device in instances in which the content capturing device satisfies one or more predefined conditions, program code instructions for receiving a selection of the content capturing device which satisfies the one or more predefined conditions with the requesting device, program code instructions providing for control of the content capturing device which is selected with the requesting device to thereby capture a desired content segment, and program code instructions providing for transmission of the desired content segment to the receiving device.

Accordingly, embodiments of the present invention may provide for improved capturing of desired content segments using a remotely located content capturing device.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus providing for transmission of a desired content segment to a receiving device according to an example embodiment of the present invention;

FIG. 3 illustrates a flowchart according to an example method providing for transmission of a desired content segment to a receiving device in accordance with an example embodiment of the present invention;

FIG. 4 illustrates an embodiment of a user terminal according to an example embodiment of the present invention; and

FIG. 5 illustrates an example embodiment of a content capturing device according to an example embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

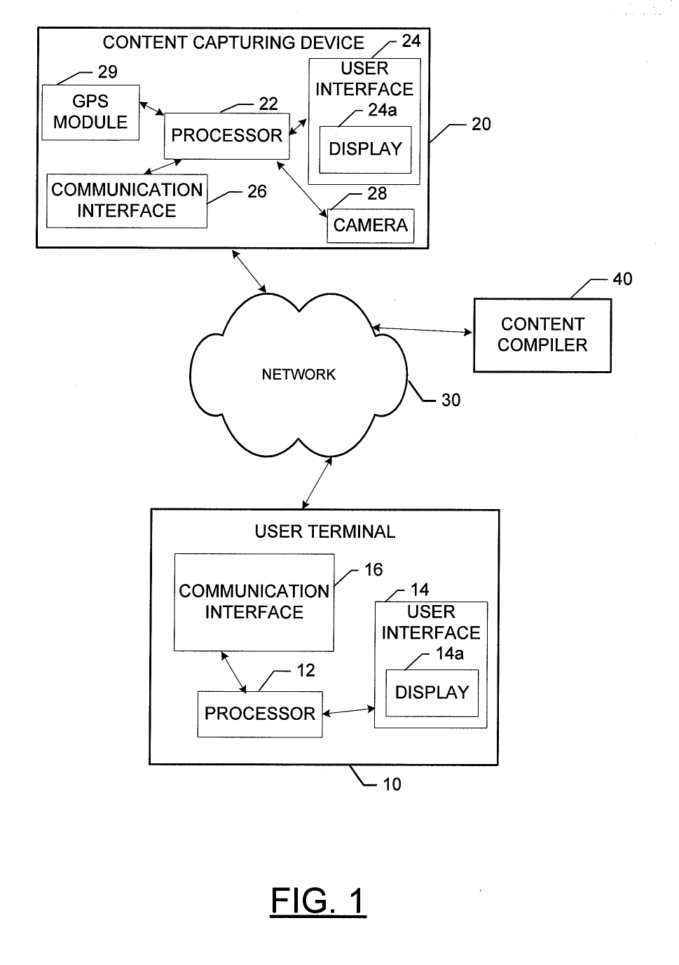

As indicated above, embodiments of the present invention may be employed in methods, apparatuses and computer program products providing for control of a content capturing device with a requesting device to thereby capture a desired content segment. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention.

The user terminal 10 be configured to request a desired content segment, such as a picture, video, or audio clip, and hence may be referred to as a requesting device. The user terminal 10 may include or otherwise be in communication with a processor 12, a user interface 14, and a communication interface 16. The user interface 14 may be used to find and request content as will be described below. The content may be received through the communication interface 16 and displayed on a display 14a, which may comprise a portion of the user interface 14.

The processor 12 may be embodied in a number of different ways. For example, the processor 12 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 12 may be configured to execute instructions stored in a memory device or otherwise accessible to the processor 12. Alternatively or additionally, the processor 12 may be configured to execute hard coded functionality. As such, whether configured by hardware or software methods, or by a combination thereof, the processor 12 may represent an entity (for example, physically embodied in circuitry) capable of performing operations according to embodiments of the present invention while configured accordingly. Thus, for example, when the processor 12 is embodied as an ASIC, FPGA or the like, the processor 12 may be specifically configured hardware for conducting the operations described herein. Alternatively, as another example, when the processor 12 is embodied as an executor of software instructions, the instructions may specifically configure the processor 12 to perform the algorithms and/or operations described herein when the instructions are executed. However, in some cases, the processor 12 may be a processor of a specific device (for example, a mobile terminal or network device such as a server) adapted for employing embodiments of the present invention by further configuration of the processor 12 by instructions for performing the algorithms and/or operations described herein. The processor 12 may include, among other things, a clock, an arithmetic logic unit (ALU) and logic gates configured to support operation of the processor 12.

In some embodiments the user terminal 10 may be capable of communicating with a content capturing device 20 which may in some embodiments also comprise a user terminal. The content capturing device 20 may include or otherwise be in communication with a processor 22, a user interface 24, a communication interface 26, a camera 28, and a GPS module 29. The content capturing device 20 may use the user interface 24 to control the camera 28 and thereby capture content segments which may thereby be transmitted through the communication interface 26. A display 24a may assist the user of the content capturing device 20 in capturing the content. Further, a GPS module 29 may be used to provide the location of the content capturing device 20 such that the user terminal 10 may use this information to determine that the content capturing device 20 may be in a location where it could capture a desired content segment.

The processor 22 may be embodied in a number of different ways. For example, the processor 22 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 22 may be configured to execute instructions stored in a memory device or otherwise accessible to the processor 22. Alternatively or additionally, the processor 22 may be configured to execute hard coded functionality. As such, whether configured by hardware or software methods, or by a combination thereof, the processor 22 may represent an entity (for example, physically embodied in circuitry) capable of performing operations according to embodiments of the present invention while configured accordingly. Thus, for example, when the processor 22 is embodied as an ASIC, FPGA or the like, the processor 22 may be specifically configured hardware for conducting the operations described herein. Alternatively, as another example, when the processor 22 is embodied as an executor of software instructions, the instructions may specifically configure the processor 22 to perform the algorithms and/or operations described herein when the instructions are executed. However, in some cases, the processor 22 may be a processor of a specific device (for example, a mobile terminal or network device such as a server) adapted for employing embodiments of the present invention by further configuration of the processor 22 by instructions for performing the algorithms and/or operations described herein. The processor 22 may include, among other things, a clock, an arithmetic logic unit (ALU) and logic gates configured to support operation of the processor 22.

Communication between the user terminal 10 and the content capturing device 20 may in some embodiments occur, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The system may further comprise a content compiler 40 which may be in communication with the user terminal 10 and the content capturing device 20 either directly, or through the network 30. As will be described in detail below, the content compiler 40 may be configured to receive content from the content capturing device 20, and make it accessible to the user terminal 10. Specifically, in some embodiments the content compiler 40 may provide the user terminal 10 with a content preview corresponding to a content segment captured by the content capturing device 20 which allows the user terminal to select the content capturing device for control in order to capture a desired content segment. The content compiler 40 may for example be a server, server bank or other computer or other computing device or node configured to compile content. The content compiler 40 may have any number of functions or associations with various services. As such, for example, the content compiler 40 may be a platform such as a dedicated server (or server bank), or the content compiler may be a backend server associated with one or more other functions or services. Thus, the content compiler 40 represents a potential host for a plurality of different content. The content compiler 40 may receive and distribute commercial and/or non-commercial content. Accordingly, the operations performed by the content compiler 40 may or may not comprise processing payment in exchange for distributing the content. In some embodiments payment may be processed by a separate device.

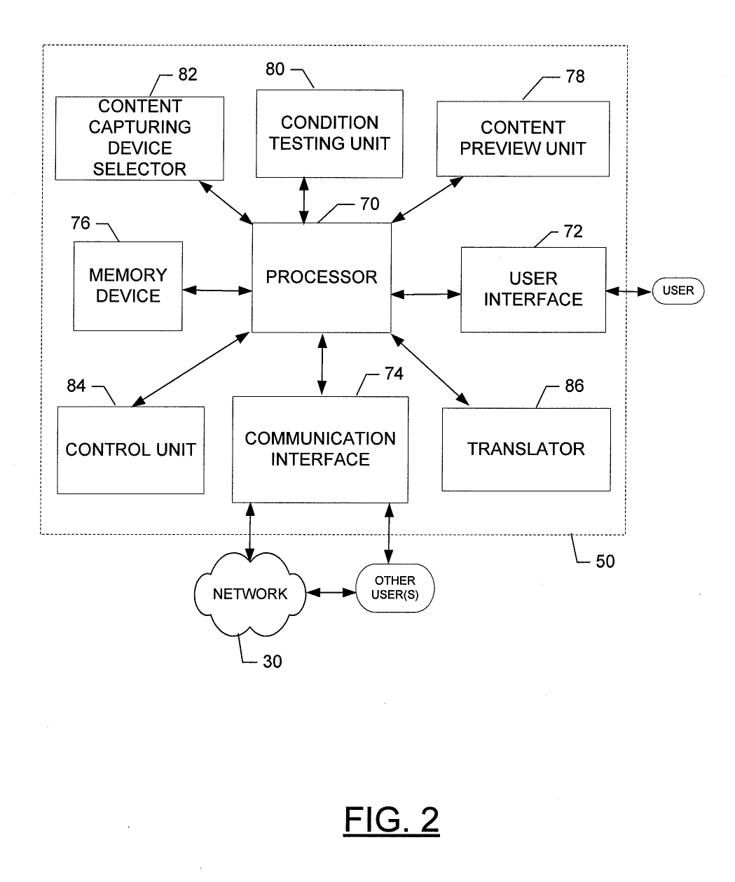

In an example embodiment, an apparatus 50 is provided that may be employed by devices performing example embodiments of the present invention. The apparatus 50 may be embodied, for example, as any device hosting, including, controlling or otherwise comprising the content compiler 40. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 is configured to compile content, such as content received from the content capturing device 20, and allow the content to be accessed by devices, such as the user terminal 10. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (for example, a mobile terminal or network device such as a server) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

In some embodiments the apparatus 50 may include a content preview unit 78. The processor 70 may be embodied as, include or otherwise control the content preview unit 78. The content preview unit may employ or embody logic which converts a content segment received by the apparatus 50 into a content preview. For example, the apparatus 50 may receive a content segment from the content capturing device and then convert the content segment into a content preview. A content preview, as used herein, refers to a content segment which has been compressed and/or converted into an alternate format. For example, the apparatus 50 may receive a content segment such as a video clip from the content capturing device 20. The content preview unit 78 may thereby select a frame from the video clip and compress it into a standardized thumbnail size image, or reduce the frame rate of the video clip. Alternatively, if the apparatus 50 receives a photograph from the content capturing device 20, the content preview unit 78 may compress the photograph into a standardized thumbnail size image such as by using known compression techniques (for example, Joint Photographic Experts Group (JPEG) compression). In another exemplary embodiment, if the apparatus 50 receives an audio clip from the content capturing device 20, the content preview unit 78 may create a graphical representation of the audio clip in the standardized thumbnail size such as a graph of the audio output over the duration of the clip. In some embodiments the compression and/or standardization may occur within the content producing device 20 with the apparatus 50 thereby receiving the content preview from the content producing device. In such embodiments the apparatus 50 receives a content segment which may also be considered to be a content preview.

The apparatus 50 may make the content previews available for viewing by the user terminal 10. However, in some embodiments the content capturing device 20 must satisfy one or more predefined conditions before the content previews are made available to the user terminal 10. The apparatus 50 may use a condition testing unit 80 to test whether the predefined conditions are satisfied. The processor 70 may be embodied as, include or otherwise control the condition testing unit 80. The predefined conditions may include, for example, that the content capturing device 20 be within a predefined distance from the location at which the content was captured. The condition testing unit 80 may make this determination, for example, using information supplied from the GPS module 29 of the content capturing device 20. Another example of a predefined condition is that the content capturing device 20 be available to capture a desired content segment. For example, if the content capturing unit 20 is busy capturing content for another user, or is offline, the content capturing unit may not be available to capture the desired content segment. In some embodiments the condition testing unit 80 may determine whether the content segment is older than a predetermined time limit. For example, the condition testing unit 80 could be configured to test whether the captured image is more than half an hour old. At the expiration of the predefined time limit the apparatus 50 may archive the content preview or delete the content preview in some embodiments. Accordingly, the condition testing unit 80 may test one or more predefined conditions.

The apparatus 50 may additionally comprise a content capturing device selector 82. The content capturing device selector 82 may make the content capturing device 20 available for selection by the user terminal 10. The processor 70 may be embodied as, include or otherwise control the content capturing device selector 82. In some embodiments, the content capturing device selector 82 may allow the user terminal 10 to sort the content previews and select the content capturing device 20 which captured a content preview of interest. For example, the content capturing device selector 82 may make the content previews available for display on the user terminal 10 and sortable based on the location at which the content was captured. However, the content capturing device selector 82 may in some embodiments use the condition testing unit 80 to test one or more predefined conditions and thereby prevent selection of a content capturing device 20 when it fails to satisfy one or more of the predefined conditions.

The apparatus 50 may further comprise a control unit 84. In some embodiments the processor 70 may be embodied as, include or otherwise control the control unit 84. The control unit 84 may be used to control the content capturing device 20. As will be described below, after a content capturing device 20 is selected, such as by using the content capturing device selector 82, the user terminal 10 may control the content capturing device to thereby capture a desired content segment.

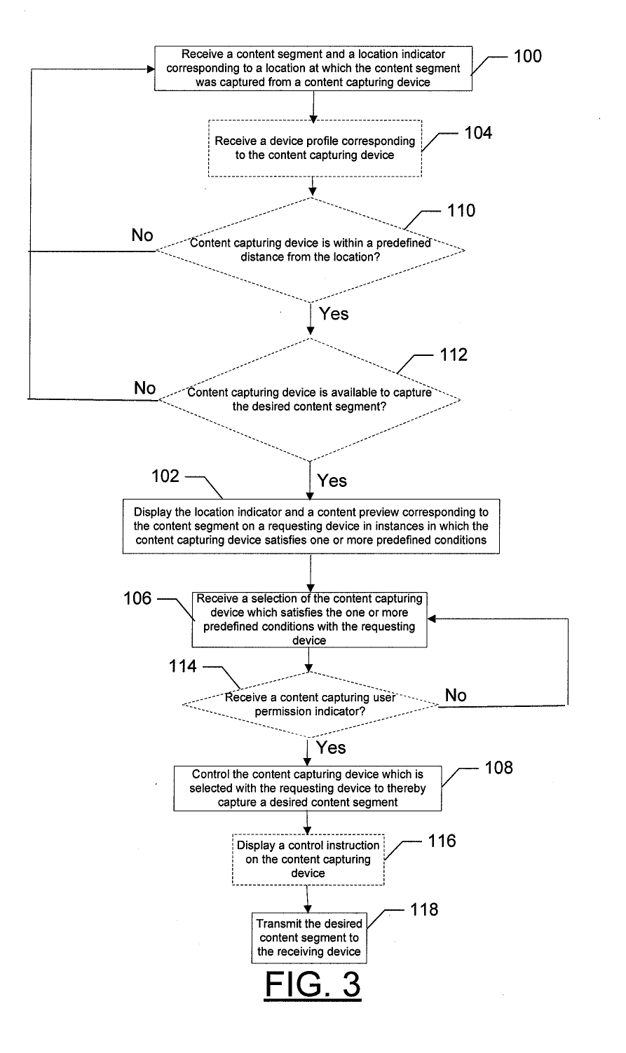

In terms of methods associated with embodiments of the present invention, the above-described apparatus 50 or other embodiments of apparatuses may be employed. In this regard, FIG. 3 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method comprises receiving a content segment and a location indicator corresponding to a location at which the content segment was captured from a content capturing device at operation 100. This may occur, for example, when the user of the content capturing device 20 wants to indicate that he is available to capture content at that location. In some embodiments the user of the content capturing device 20 may offer his or her services in exchange for money, whereas in other embodiments the user of the content capturing device may be willing to capture content for free. The method further includes providing for display of the location indicator and a content preview corresponding to the content segment on a requesting device in instances in which the content capturing device satisfies one or more predefined conditions at operation 102.

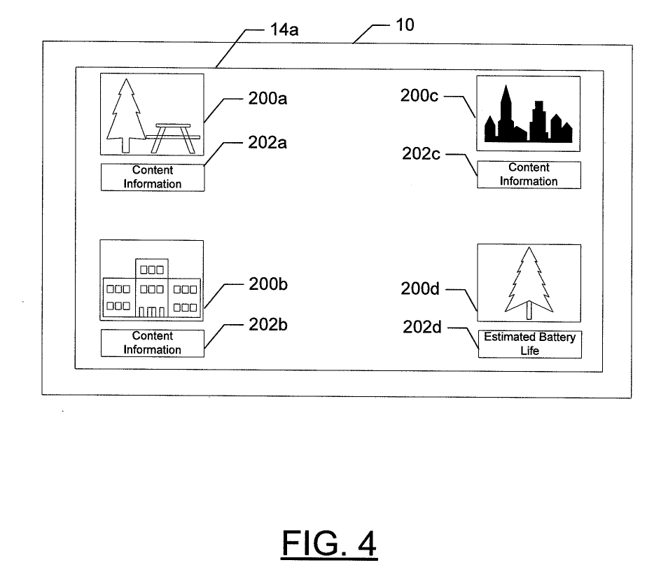

By displaying a content preview and a corresponding location indicator, a user may be able to find content of interest. For example, FIG. 4 illustrates the user terminal 10 when it acts as the requesting device. As illustrated, the user terminal 10 may display on its display 14a a plurality of content previews 200a-d (collectively, 200) which correspond to content segments received from one or more content capturing devices 20. The display 14a may also display related content information 202a-d (collectively, 202) which may include the location indicator. In some embodiments the method may further include receiving a device profile corresponding to the content capturing device at operation 104. By receiving the device profile, it may be possible for the user of the user terminal 10 to know the capabilities of the content capturing unit 20. For example, the user of the user terminal 10 may want to know the resolution of the camera 28 of the content capturing unit 20 and the capacity of any memory the content capturing device may have. Thus, the user of the user terminal 10 may be able to view the content previews 200 and corresponding content information 202 on the display 14a.

After displaying the location indicator and the content preview at operation 102, the method further comprises receiving a selection of the content capturing device which satisfies the one or more predefined conditions with the requesting device at operation 106. In order to facilitate the selection of a content capturing device, the content previews and/or the content capturing devices 20 may be sortable. In some embodiments the content previews and or the content capturing devices 20 may be sortable based on the location at which the content segment was captured. For example, in FIG. 4, the user of the user terminal 10 may sort the content previews 200 and select the content capturing device 20 which corresponds to the content preview 200a if this particular content preview and/or the associated content information 202a, which may include the location at which the content was captured, are of interest to the user. Additionally, after selecting the content capturing device at operation 106, the method further comprises providing for control of the content capturing device which is selected with the requesting device to thereby capture a desired content segment at operation 108.

However, as described above in operation 102, in some embodiments the content preview 200 will only be displayed when the corresponding content capturing device 20 satisfies one or more predefined conditions. By preventing the display of the content preview 200 when the one or more predefined conditions are not satisfied, the method may prevent the user of the user terminal 10 from attempting to select and control a content capturing device 20 which is not willing or able to capture a desired content segment. For example, the predefined conditions may comprise determining that the content capturing device is within a predefined distance from the location at operation 110, and determining that the content capturing device is available to capture the desired content segment at operation 112. By insuring that the content capturing device 20 is within a predefined distance from the location at which the content segment was captured, the method may thereby prevent the user of the user terminal 10 from selecting a content capturing device which may not be able to capture a desired content segment since the content capturing device has moved to a new location. For example, if the content capturing device 20 has moved to a new location which is several miles away from the original location, it may not be able to capture a desired content segment near the original location at which the content segment was captured. Similarly, if the content capturing device 20 is unavailable, as for example by being offline, busy, or refusing requests for capturing content segments, this particular content capturing device may not be able to assist the user terminal 10 in capturing a desired content segment. In some embodiments the availability of the content capturing device 20 may automatically time out after a predefined period of time. This may, for example, be used to make sure that the content preview 200 is current. As illustrated at the operations 110, 112 checking the predefined conditions, if they are not satisfied, the method returns to operation 100 to receive a new content segment.

Further, the method may comprise receiving a content capturing user permission indicator prior at operation 114 prior to providing for control of the content capturing device at operation 108. Thus, the method may in some embodiments require the content capturing device 20 to accept control by the user terminal 10. This may, for example, address privacy concerns and prevent unwanted control of the content capturing device 20. Further, in some embodiments wherein the user of the content capturing device 20 is capturing content for commercial purposes, the user of the content capturing device may withhold permission until agreement with the user of the user terminal 10 is reached as to a price for allowing control of the content capturing device. Accordingly, when a permission indicator is not received, the method may return to selecting a different content control device at operation 106. Thereby, in instance in which permission is not received, the requesting device may have the opportunity to select a different content capturing device 20.

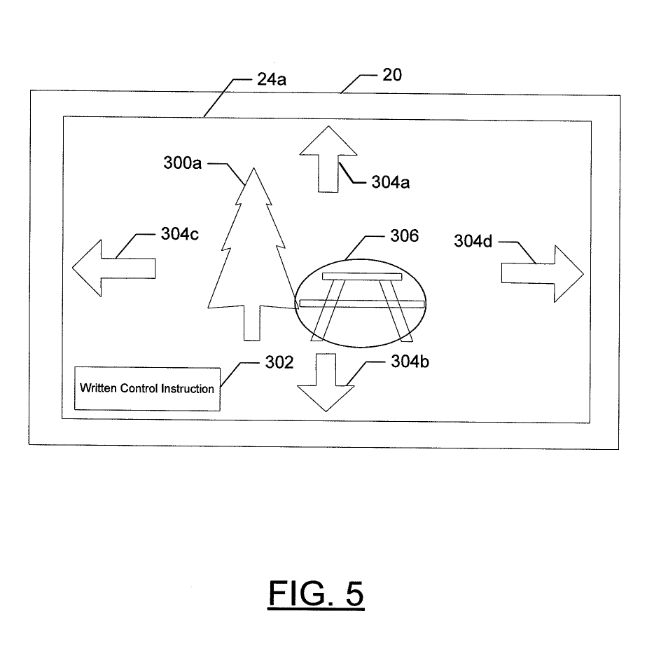

Control of the content capturing device 20 may occur directly in some embodiments, such as by providing the user terminal 10 with a set of controls which enable the user terminal to operate functions of the content capturing device. For example, the user terminal 10 may be provided with controls for the zoom, focus, shutter speed, etc. of the content capturing device 20. The user terminal 10 may also select the resolution of the camera 28 of the content capturing device 20 and/or the duration of the content segment which will be captured. However, control of the content capturing device 20 may occur indirectly in some embodiments. For example, the operation 108 of providing for control of the content capturing device may comprise providing for display of a control instruction on the content capturing device at operation 116. For example, as illustrated in FIG. 5, in some embodiments the content capturing device 20 may display one or more control instructions on the display 24a. For example, the content capturing device 20 may be provided with a written control instruction 302 on the display 24a which tells the user what to do in order to capture the desired content segment. Accordingly, for example, the instructions may say “Center the photograph on the table.” In some embodiments the user of the user terminal 10 and the content capturing device 20 may speak different languages. Accordingly, in some embodiments the apparatus 50 may translate any instructions provided by the user of the mobile terminal 10. The translation may in some embodiments occur by using user profiles which are provided by the user terminal 10 and the content capturing device 20.

In some embodiments the control instruction may indicate a desired directional movement of the content capturing device 20. For example, the control instructions may comprise one or more arrows 304a-d, which indicate a desired directional movement of the content capturing device 20. Thus, the arrows 304a-d may instruct the user of the content capturing device 20 to pan the content capturing device left, right, up, down, backward, forward, etc. In some embodiments the user of the user terminal 10 may indicate directly on the content segment 300a displayed on the display 24a with a desired content indicator 306 which may, for example, be used to annotate the content segment with a circle on the portion of the content segment which is of interest. Other displayed indicators may instruct the user of the content capturing device 20 to conduct actions such as tilt, zoom, transition between landscape/portrait, exposure, etc. However, various other embodiments of control instructions may be employed, such as by vibration, audio output, etc. In some embodiments the full content segment may be sent from the content capturing device 20 to the user terminal 10 in order to allow the user terminal to provide control instructions. However, in some embodiments the control instructions may be bundled into settings profiles in order to reduce bandwidth consumption. Control may be implemented as HTTP transport with Extensible Markup Language (XML) payload carrying the control instructions, or using Session Initiation Protocol (SIP) transport with Session Description Protocol (“SDP”) payload carrying the control instructions. However, various other protocols may be employed in other embodiments. In order to further reduce bandwidth consumption and the potential for latency issues, in some embodiments a reduced resolution and/or reduced frame rate content segment may be sent to the user terminal 10, such as by using multi-frame JPEG encoding. Thus, using the control instructions, the content capturing device 20 may capture the desired content segment. Accordingly, the method further comprises providing for transmission of the desired content segment to the receiving device at operation 118.

In an example embodiment, an apparatus for performing the method of FIG. 3 and other methods described above may comprise a processor (for example, the processor 70) configured to perform some or each of the operations (100-118) described above. The processor may, for example, be configured to perform the operations (100-118) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-118 may comprise, for example, the processor 70, the user interface 72, the communication interface 74, the content preview unit 78, the condition testing unit 80, the content capturing device selector 82, the control unit 84, and the translator 86, and/or an algorithm executed by the processor for processing information as described above. However, the above-described portions of the apparatus 50 as they relate to the operations of the method illustrated in FIG. 3 are merely examples, and it should be understood that various other embodiments may be possible.

In some embodiments the operation 100 of receiving a content segment and a location indicator corresponding to a location at which the content was captured from a content capturing device may be conducted by means, such as the processor 70 in conjunction with the communication interface 74. Further, providing for display of the location indicator and a content preview corresponding to the content segment on a requesting content device in instances in which the content capturing device satisfies one or more predefined conditions at operation 102 may be conducted by means, such as the processor 70 in conjunction with the content preview unit 78. Additionally, receiving a selection of the content capturing device which satisfies the one or more predefined conditions with the requesting device at operation 106 may be carried out by means, such as the processor 70 or the content capturing device selector 82 in conjunction with the communication interface 74. Accordingly, a requesting device such as the user terminal 10 may be able to view the content previews 200 and select the content capturing unit 20 which captured the content of interest. The method also comprises providing for control of the content capturing device which is selected with the requesting device to thereby capture a desired content segment at operation 108 which may be conducted by means, such as the processor 70 in conjunction with the control unit 84. Additionally, providing for transmission of the desired content segment to the receiving device at operation 118 may be conducted by means, such as the processor 70 in conjunction with the communication interface 74.

In some embodiments the method may further include receiving a device profile corresponding to the content capturing device at operation 104, which may be conducted by means, such as the processor 70 in conjunction with the communication interface 74. Further, determining that the content capturing device is within a predefined distance from the location at operation 110 and determining that the content capturing device is available to capture the desired content segment at operation 112 may be conducted by means, such as the processor 70 in conjunction with the condition testing unit 80. Also, receiving a content capturing user permission indicator at operation 114 may be conducted by means, such as the processor 70 in conjunction with condition testing unit 80 prior to providing for control of the content capturing device at operation 108. The method may further include providing for display of a control instruction on the content capturing device at operation 116, which may be conducted by means, such as the processor 70 in conjunction with control unit 84.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to at least perform:
receiving a content segment and a location indicator corresponding to a location at which the content segment was captured from a content capturing device;
providing for display of the location indicator and a content preview corresponding to the content segment on a requesting device in instances in which the content capturing device satisfies one or more predefined conditions;
receiving a selection of the content capturing device which satisfies the one or more predefined conditions with the requesting device;
providing for control of the content capturing device which is selected with the requesting device to thereby capture a desired content segment; and
providing for transmission of the desired content segment to the receiving device.

2. The apparatus of claim 1, wherein providing for control of the content capturing device comprises providing for display of a control instruction on the content capturing device.

3. The apparatus of claim 2, wherein the control instruction indicates a desired directional movement of the content capturing device.

4. The apparatus of claim 1, further comprising receiving a content capturing user permission indicator prior to providing for control of the content capturing device.

5. The apparatus of claim 1, wherein the one or more predefined conditions comprise determining that the content capturing device is within a predefined distance from the location.

6. The apparatus of claim 1, wherein the one or more predefined conditions comprise determining that the content capturing device is available to capture the desired content segment.

7. The apparatus of claim 1, further comprising receiving a device profile corresponding to the content capturing device.

8. A method comprising:
receiving a content segment and a location indicator corresponding to a location at which the content segment was captured from a content capturing device;
providing for display of the location indicator and a content preview corresponding to the content segment on a requesting device in instances in which the content capturing device satisfies one or more predefined conditions;
receiving a selection of the content capturing device which satisfies the one or more predefined conditions with the requesting device;
providing for control of the content capturing device which is selected with the requesting device to thereby capture a desired content segment; and
providing for transmission of the desired content segment to the receiving device.

9. The method of claim 8, wherein providing for control of the content capturing device comprises providing for display of a control instruction on the content capturing device.

10. The apparatus of claim 9, wherein the control instruction indicates a desired directional movement of the content capturing device.

11. The apparatus of claim 8, further comprising receiving a content capturing user permission indicator prior to providing for control of the content capturing device.

12. The apparatus of claim 8, wherein the one or more predefined conditions comprise determining that the content capturing device is within a predefined distance from the location.

13. The apparatus of claim 8, wherein the one or more predefined conditions comprise determining that the content capturing device is available to capture the desired content segment.

14. The apparatus of claim 13, further comprising receiving a device profile corresponding to the content capturing device.

15. A computer program product comprising at least one computer-readable storage medium having computer-executable program code portions stored therein, the computer-executable program code portions comprising:
program code instructions for receiving a content segment and a location indicator corresponding to a location at which the content segment was captured from a content capturing device;
program code instructions providing for display of the location indicator and a content preview corresponding to the content segment on a requesting device in instances in which the content capturing device satisfies one or more predefined conditions;
program code instructions for receiving a selection of the content capturing device which satisfies the one or more predefined conditions with the requesting device;
program code instructions providing for control of the content capturing device which is selected with the requesting device to thereby capture a desired content segment; and
program code instructions providing for transmission of the desired content segment to the receiving device.

16. The computer program product of claim 15, wherein program code instructions providing for control of the content capturing device comprise program code instructions providing for display of a control instruction on the content capturing device.

17. The computer program product of claim 16, wherein the control instruction indicates a desired directional movement of the content capturing device.

18. The computer program product of claim 15, further comprising program code instructions for receiving a content capturing user permission indicator prior to providing for control of the content capturing device.

19. The computer program product of claim 15, wherein the one or more predefined conditions comprise program code instructions for determining that the content capturing device is within a predefined distance from the location.

20. The computer program product of claim 15, wherein the one or more predefined conditions comprise program code instructions for determining that the content capturing device is available to capture the desired content segment.
